(19) United States
(12) Patent Application Publication
(10) Pub. No.: US 2004/0128701 A1
(43) Pub. Date: Jul. 1, 2004

(54) Client device and server device

(75) Inventors: Toshimitsu Kaneko, Tokyo (JP); Toru Kambayashi, Tokyo (JP); Hideki Takahashi, Tokyo (JP); Yoshihiro Kikuchi, Tokyo (JP); Chihiro Nakazawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/669,553

(22) Filed: Sep. 25, 2003

(30) Foreign Application Priority Data
Sep. 26, 2002 (JP) 2002-282015

(51) Int. Cl. H04N 7/16; H04N 7/173

(52) U.S. Cl. 725/136; 725/135; 725/112; 725/113

(57) ABSTRACT

In order to eliminate viewer's waiting time for downloading metadata on a network when enjoying hypermedia by combining videos in viewer's possession and the metadata, a client device holds video data, metadata related to the video data is recorded in a server device; the server device sends the metadata to the client device through the network at the request from the client device; and the client device processes the sent metadata, thus realizing hypermedia together with local video data.

### CROSSREFERENCE TO RELATED APPLICATIONS

This application is based upon and claims the benefit of priority from the prior Japanese Patent Application No. 2002-282015, filed on Sep. 26, 2002; the entire contents of which are incorporated herein by reference.

### BACKGROUND OF THE INVENTION

The present invention relates to a server device, a client device, and a system for realizing video hypermedia by combining local video data and metadata on a network.

Hypermedia is a system in which a connection called a hyperlink is defined among media including a moving image, a still image, audio, and text, and which allows mutual or one-way reference. For example, HTML home pages which can be viewed through the Internet include text and still images, for which links are defined everywhere. Designating the link allows related information of link-destination to be immediately displayed. Since related information can be accessed by directly indicating a word or a phrase of interest, it is easy and intuitive to operate.

On the other hand, in hypermedia for video, not for text and still images, links are defined from people and objects in video to related contents including text and still images for describing them. Accordingly, when the viewers indicate the objects, the related contents are displayed. In this case, it becomes necessary to provide data (object-area data) indicating a spatiotemporal area of the object in the video.

For the object-area data, it is possible to use methods of describing a binary or more mask image sequence, arbitrary shape coding by MPEG-4 (ISO/IEC 14496), and describing the locus of the feature of a figure, which is described in JP-A-11-20387.

In order to achieve the video hypermedia, in addition to those, it becomes necessary to provide data (script data) that describes an action of displaying related contents when an object is indicated, contents data to be displayed and so on. These data are called metadata in contrast to video.

For the viewers to enjoy video hypermedia, for example, it is desirable to provide video CDs and DVDs in which both the video and the metadata are recorded. Also, the use of streaming distribution through a network such as the Internet allows the viewers to view video hypermedia by receiving both of the video and the metadata.

However, since already-owned video CDs and DVDs have no metadata, the viewers cannot enjoy hypermedia with such videos. One of methods for enjoying video hypermedia with the video CDs and DVDs having no metadata is to newly produce metadata for the videos and to distribute them to the viewers.

The metadata may be distributed while being recorded in CDS, flexible discs, DVDs and so on; however, it is most convenient to distribute the metadata through a network. When the viewers can access the network, they can easily download the metadata at home, which allows the viewers to view video CDs and DVDS that could only be played back previously as hypermedia and to view their related information.

However, when only the metadata is downloaded through a network, the viewers must wait to play back the video until the completion of downloading when the metadata is large in volume. In order to play back the video without a wait, there is a method of receiving video data and metadata by streaming distribution. However, videos that can be sent by streaming distribution have low image quality, and high-quality videos in the video CDs and DVDs in viewer's possession cannot be well utilized.

As described above, in order to enjoy video hypermedia by combining videos in possession and metadata on a network, the videos in viewer's possession must be utilized and also the viewer's waiting time for downloading the metadata must be eliminated.

### BRIEF SUMMARY OF THE INVENTION

Accordingly, it is an object of the present invention to provide devices and a system for eliminating viewer's waiting time for downloading metadata when viewers enjoy hyper media by combining videos in viewer's possession and metadata on a network.

According to embodiments of the present invention, a client device is provided which is capable of accessing a. hypermedia-data server device through a network. The client device includes a playback unit to play back a moving image; a time-stamp transmission unit to transmit the time stamp of the image in playback mode to the server device; a metadata receiving unit to receive metadata having information related to the contents of the image at each time stamp from the server device by streaming distribution in synchronization with the playback of the moving image; and a controller to display the received metadata or performing control on the basis of the metadata in synchronization with the playback of the image.

According to embodiments of the present invention, a server device is provided which is capable of accessing a hypermedia-data client device through a network. The server device includes a metadata storage unit to store metadata having information related to the contents of an image corresponding to each time stamp of a moving image to be played back by the client device; a time-stamp receiving unit to receive the time stamp of the image to be played back, the time stamp being transmitted from the client device; and a metadata transmission unit to transmit the stored metadata to the client device by streaming distribution in synchronization with the playback of the image in accordance with the received time stamp.

According to embodiments of the present invention, a method for playing back a moving image in a client device is provided which is capable of accessing a hypermedia-data server device through a network. The method includes a playback step of playing back the moving image; a time-stamp transmission step of transmitting the time stamp of the image in playback mode to the server device; a metadata receiving step of receiving metadata having information related to the contents of the image at each time stamp from the server device by streaming distribution in synchronization with the playback of the moving image; and a control step of displaying the received metadata or performing control on the basis of the metadata in synchronization with the playback of the image.

According to embodiments of the present invention, a method for transmitting data in a server device is provided which is capable of accessing a hypermedia-data client device through a network. The method includes a time-stamp receiving step of receiving the time stamp of an image to be played back, the time stamp being transmitted from the client device; and a metadata transmission step of transmitting metadata having information related to the contents of an image corresponding to each time stamp of a moving image to be played back by the client device to the client device by streaming distribution in synchronization with the playback of the image on the basis of the received time stamp.

According to embodiments of the present invention, even videos in viewer's possession can receive new metadata through a network. Therefore, the viewer can enjoy it as video hypermedia.

The viewer receives metadata by streaming distribution through a network in synchronization with the playback of the video. Accordingly, there is no need for the viewer to wait for the playback of the video unlike when downloading the metadata.

Furthermore, since videos in viewer's possession are used, high-quality images can be enjoyed as compared with images by streaming distribution for each video.

### BRIEF DESCRIPTION OF THE DRAWINGS

FIG. 1 is a block diagram showing the structure of a hypermedia system according to an embodiment of the present invention;

FIG. 2 is a diagram showing an example of the structure of object data according to an embodiment of the invention;

FIG. 3 is a diagram showing an example of the screen display of a hypermedia system according to an embodiment of the invention;

FIG. 4 is a diagram of an example of server-client communication according to an embodiment of the invention;

FIG. 5 is a flowchart of the process of determining the scheduling of metadata transmission according to an embodiment of the invention;

FIG. 6 is a diagram of an example of the process of packetizing object data according to an embodiment of the invention;

FIG. 7 is a diagram of an example of the structure of packet data according to an embodiment of the invention;

FIG. 8 is a diagram of another process of packetizing object data according to an embodiment of the invention;

FIG. 9 is a diagram of an example of sorting a metadata packet according to an embodiment of the invention;

FIG. 10 is a flowchart of the process of determining the timing of packet transmission according to an embodiment of the invention;

FIG. 11 is a diagram of an example of an access-point table of a packet according to an embodiment of the invention;

FIG. 12 is a flowchart for making an access-point table of a packet according to an embodiment of the invention;

FIG. 13 is a flowchart of another method of determining the position of starting the transmission of metadata by a streaming server when a jump command is sent from a streaming client to the streaming server, according to an embodiment of the invention;

FIG. 14 is a flowchart for starting metadata transmission when an access-point table for packets formed by the method of FIG. 13 is used, according to an embodiment of the invention; and

FIG. 15 is a diagram of an example of an object-data schedule table according to an embodiment of the invention.

### DETAILED DESCRIPTION OF THE INVENTION

An embodiment of the present invention will be described hereinafter with reference to the drawings.

(1) Structure of Hypermedia System

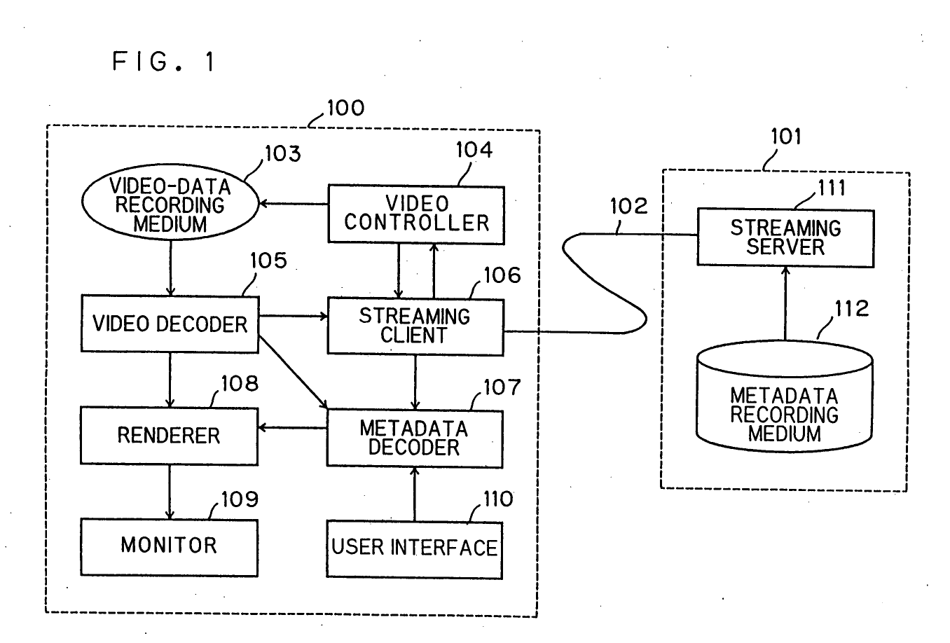

FIG. 1 is a block diagram showing the structure of a hypermedia system according to an embodiment of the present invention. The function of each component will be described with reference to the drawing.

Reference numeral 100 denotes a client device; numeral 101 denotes a server device; and numeral 102 denotes a network connecting the server device 101 and the client device 100. Reference numerals 103 to 110 designate devices included in the client device 100; and numerals 111 and 112 indicate devices included in the server device 101.

The client device 100 holds video data, and the server device 101 records metadata related to the video data. The server device 101 sends the metadata to the client device 100 through the network 102 by streaming distribution at the request from the client device 100. The client device 100 processes the transmitted metadata to realize hypermedia together with local video data.

The word, streaming distribution, means that when audio and video images are distributed on the Internet, they are played back not after the user has completed to download the file but while the user are downloading it. Accordingly, even motion-video and audio data with large volume of data can be played back without a wait.

A video-data recording medium 103, such as a DVD, a video CD, a video tape, a hard disk, and a semiconductor memory, holds digital or analog video data.

A video controller 104 controls the action of the video-data recording medium 103. The video controller 104 issues an instruction to start and stop the reading of video data and to access a desired position in the video data.

A video decoder 105 decodes inputted video data to extract video pixel information when the video data recorded in the video-data recording medium 103 is digitally compressed.

A streaming client 106 receives the metadata transmitted from the server device 101 through the network 102 and sends it to a metadata decoder 107 in sequence. The streaming client 106 controls the communication with the server device 101 with reference to the time stamp of video in playback mode inputted from the video decoder 105. Here, the word, time stamp, denotes the time of playback from the initial time when a head moving image is played back, which is also called video time.

The metadata decoder 107 processes the metadata inputted from the streaming client 106. Specifically, the metadata decoder 107 produces image data to be displayed with reference to the time stamp of the video in playback mode inputted from the video decoder 105, and outputs it to a renderer 108, determines information to be displayed for the input through a user interface 110 by the user, or deletes metadata that has become unnecessary from a memory.

The renderer 108 draws the image inputted from the video decoder 105 onto a monitor 109. To the renderer 108, an image is inputted not only from the video decoder 105 but also from the metadata decoder 107. The renderer 108 composes both the images and draws it on the monitor 109.

Examples of the monitor 109 are displays capable of displaying moving images, such as a CRT display, a liquid crystal display, and a plasma display.

The user interface 110 is a pointing device for inputting coordinates on the displayed image, such as a mouse, a touch panel, and a keyboard.

The network 102 is a data communication network between the client device 100 and the server device 101, such as a local-area network (LAN) and the Internet.

A streaming server 111 transmits metadata to the client device 100 through the network 102. The streaming server 111 also draws up a schedule for metadata transmission so as to send data required by the streaming client 106 at a proper timing.

A metadata recording medium 112, such as a hard disk, a semiconductor memory, a DVD, a video CD, and a video tape, holds metadata related to the video data recorded in the video-data recording medium 103. The metadata includes object data, which will be described later.

The metadata used in the embodiment includes areas of people and objects in video, which are recorded in the video-data recording medium 103, and actions when the objects are designated by the user. The information for each object is described in the metadata.

(2) Data Structure of Object Data

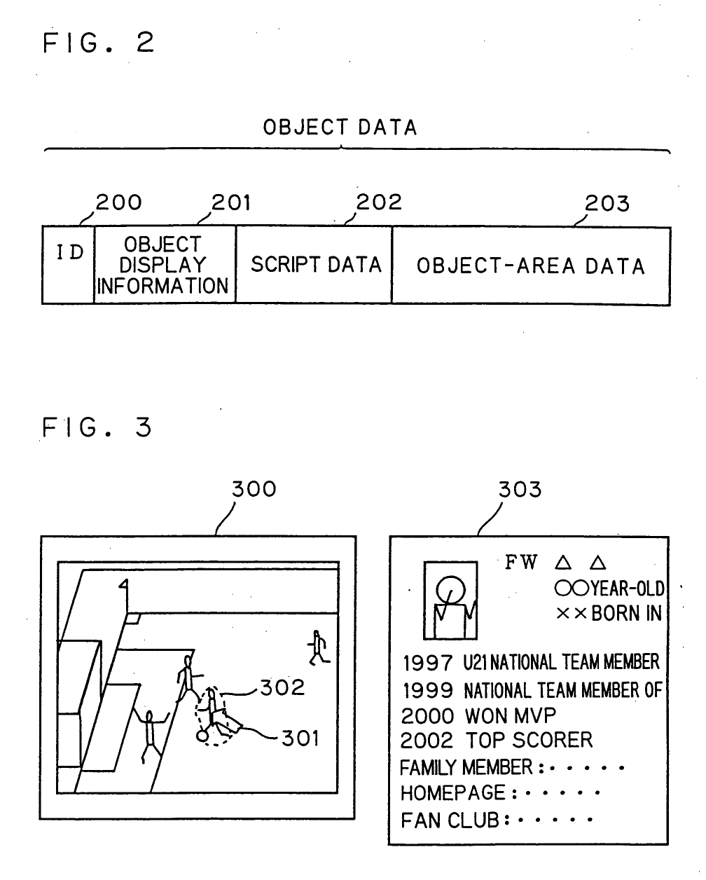

FIG. 2 shows the structure of one object of object data according to an embodiment of the invention.

An ID number 200 identifies an object. Different ID numbers are allocated to respective objects.

Object display information 201 gives a description of information about an image display related to the object. For example, the object display information 201 describes information on whether the outline of the object is to be displayed while being overlapped with the display of video in order to clearly express the object position to the user, whether the name of the object is to be displayed like a balloon near the object, what color is to be used for the outline and the balloon, and which character font is to be used. The data is described in JP-A-2002-183336.

Script data 202 describes what action should be taken when an object is designated by the user. When related information is displayed by clicking on an object, the script data 202 describes the address of the related information. The related information includes text or HTML pages, still images, and video.

Object-area data 203 is information for specifying in which area the object exists at any given time. For the data, a mask image train can be used which indicates an object area in each frame or field of video. More efficient method is MPEG-4 arbitrary shape coding (ISO/IEC 14496) in which a mask image train is compression-coded. When the object area may be approximated by a rectangle, an ellipse, or a polygon having a relatively small number of apexes, the method of Patent Document 1 can be used.

The ID number 200, the object display information 201, and the script data 202 may be omitted when unnecessary.

(3) Method for Realizing Hypermedia

A method for realizing hypermedia using object data will then be described.

Hypermedia is a system in which a connection called a hyperlink is defined among media including a moving image, a still image, audio, and text, and which allows mutual or one-way reference. Hypermedia realized by the present invention defines a hyperlink for an object area in a moving image, thus allowing reference to information related to the object.

The user points an object of interest with the user interface 110 during viewing a video recorded in the video-data recording medium 103. For example, with a mouse, the user puts a mouse cursor on a displayed object for clicking. At that time, the positional coordinates of a clicked point on the image is sent to the metadata decoder 107.

The metadata decoder 107 receives the positional coordinates sent from the user interface 110, the time stamp of the video that is now displayed sent from the video decoder 105, and object data sent from the streaming client 106 through the network 102. The metadata decoder 107 then specifies an object indicated by the user using these information. For this purpose, the metadata decoder 107 first processes the object-area data 203 in the object data and produces an object area at the inputted time stamp. When object-area data is described by the MPEG-4 arbitrary shape coding, a frame corresponding to the time stamp is decoded, and when the object area is approximately expressed by a figure, a figure at the time stamp is specified. It is then determined whether the inputted coordinates exist within the object. In the case of the MPEG-4 arbitrary shape coding, it is sufficient to determine the pixel value at the coordinates. When the object area is approximately expressed by a figure, it can be determined by a simple operation whether or not the inputted coordinates exist within the object (for more detailed information, refer to Patent Document 1). Performing the process also for other object data in the metadata decoder 107 allows a determination on which object is pointed by the user or whether the object pointed by the user is out of the object area.

When an object pointed by the user is specified, the metadata decoder 107 allows an action described in the script data 202 of the object, such as displaying a designated HTML file and playing back a designated video. The HTML file and the video file may be ones sent from the server device 101 through the network 102, or ones on the Internet.

To the metadata decoder 107, metadata is successively inputted from the streaming client 106. The metadata decoder 107 can start the process at a point of time when data sufficient to interpret the metadata has been prepared.

For example, the object data can be processed at a point of time when the object ID number 200, the object display information 201, the script data 202, and part of the object-area data 203 have been prepared. The part of the object-area data 203 is, for example, one for decoding a head frame in the MPEG-4 arbitrary shape coding.

The metadata decoder 107 also deletes metadata that has become unnecessary. The object area data 203 in the object data describes the time during which a described object exists. When the time stamp sent from the video decoder 105 has exceeded the object existing time, the data on the object is deleted from the metadata decoder 107 to save a memory.

When contents to be displayed when an object is designated have been sent as metadata, the metadata decoder 107 extracts a file name included in the header of the contents data, records data following the header, and gives the file name.

When data of the same file is sent in sequence, arriving data is added to the previous data.

The contents file may also be deleted at the same time when object data that refers the contents file is deleted.

(4) Display Example of Hypermedia System

FIG. 3 shows a display example of a hypermedia system on the monitor 109.

Reference numeral 300 denotes a video playback screen, and numeral 301 designates a mouse cursor.

Reference numeral 302 indicates an object area in a scene extracted from an object area described in object data. When the user moves the mouse cursor 301 to the object area 302 and clicks thereon, information 303 related to the clicked object is displayed.

The object area 302 may be displayed such that the user can view it, or alternatively, may not be displayed at all.

How to display it is described in the object display information 201 in the object data. The methods of display include a method of surrounding the object with a line and a method of changing the lightness and the color tone between the inside of the object and the other areas. When displaying the object area by such methods, the metadata decoder 107 produces an object area at the time according to the time stamp inputted from the video decoder 105, from the object data. The metadata decoder 107 then sends the object area to the renderer 108 to display a composite video playback image.

(5) Method for Sending Metadata

A method for sending metadata in the server device 101 to the client device 100 through the network 102 will be now described.

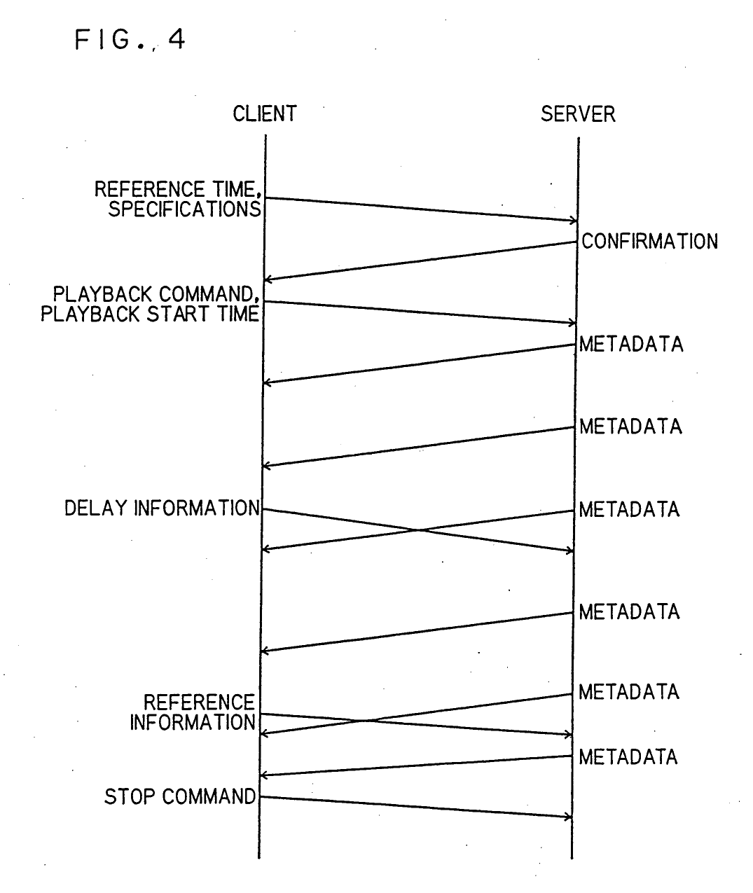

FIG. 4 shows an example of a communication between the streaming server 111 of the server device 101 and the streaming client 106 of the client device 100.

An instruction of playing back a video from the user is first transmitted to the video controller 104.

The video controller 104 instructs the video-data recording medium 103 to play back the video and sends an instruction to play back the video, the time stamp of its starting position, and information for specifying video contents to be played back to the streaming client 106. The video-contents specifying information includes a contents ID number and a file name recorded in the video.

Upon receiving the video-playback start command, the time stamp of the video-playback starting position, and the video-contents specifying information, the streaming client 106 sends reference time, the video-contents specifying information, and the specifications of the client device 100 to the server device 101.

The reference time is calculated from the time stamp of the video-playback starting position, for example, which is obtained by subtracting a certain fixed time from the time stamp of the video-playback starting position. The specifications of the client device 100 include a communication protocol, a communication speed, and a client buffer size.

The streaming server 111 first refers to the video-contents specifying information to check if the metadata of the video to be played back by the client device 100 is recorded in the metadata recording medium 112.

When the metadata has been recorded, the streaming server 111 sets a timer to the sent reference time and checks if the specifications of the client device 100 satisfies conditions for communication. When the conditions are satisfied, the streaming server 111 sends a confirmation signal to the streaming client 106.

When the metadata of the video to be played back by the client device 100 is not recorded or the conditions are not satisfied, the streaming server 111 sends a signal indicating that there is no metadata or communication is unavailable to the streaming client 106, thus communication is completed.

The timer in the server device 101 is a watch for the streaming server 111 to schedule the transmission of data, which is adjusted so as to synthesize with the time stamp of the video to be played back by the client device 100.

The streaming client 106 then sends a playback command and the time stamp of a playback starting position to the streaming server 111. Upon receiving them, the streaming server 111 specifies data that is necessary at the received time stamp from the metadata, and transmits packets including the metadata therefrom to the streaming client 106 in sequence.

The method for determining the position to start the transmission and the process of scheduling packet transmission will be specifically described later.

Even when the video controller 104 sends a video-playback start command to the streaming client 106, video playback is not immediately started. This is for the purpose of waiting for the metadata necessary at the start of video playback to be accumulated in the metadata decoder 107. When all the metadata necessary for starting video playback has been prepared, the streaming client 106 notifies the video controller 104 that the preparation has been finished, and the video controller. 104 then starts to playback the video.

The streaming client 106 periodically sends delay information to the streaming server 111 when receiving packets including metadata. The delay information indicates how long the timing at which the streaming client 106 receives the metadata is delayed from the time for playing back the video. On the contrary, it may be information that indicates how long the timing is fast. The streaming server 111 uses the information to advance the timing of transmitting the packets including the metadata when delayed, and on the other hand, to delay the timing when advanced.

The streaming client 106 also periodically transmits the reference time to the streaming server 111 when receiving packets including the metadata. The reference time at that time is the time stamp of a video in playback mode and is inputted from the video decoder 105. The streaming server 111 sets the timer for receiving the reference time to synchronize with the video in playback mode in the client device 100.

Finally, after the video has been play backed to the end or when the stop of the video playback is inputted from the user, a command to stop the video playback is sent from the video controller 104 to the streaming client 106. Upon receiving the command, the streaming client 106 sends a stop command to the streaming server 111. Upon receiving the stop command, the streaming server 111 finishes the data transmission. The transmission of all metadata sometimes finishes before the streaming client 106 sends the stop command. In such a case, the streaming server 111 sends a message to tell that the data transmission has been finished to the streaming client 106, and thus the communication is finished.

In addition to the playback command and the stop command, which have already been described, the commands sent from the client device 100 to the server device 101 include a suspend command, a suspend release command, and a jump command. When a suspend command is issued from the user during the reception of metadata, the command is sent to the streaming server 111. Upon receiving the command, the streaming server 111 suspends the transmission of metadata. When a suspend release command is issued from the user during the suspension, the streaming client 106 sends the suspend release command to the streaming server 111. Upon receiving the command, the streaming server 111 restarts the suspended transmission of metadata.

The jump command is sent from the streaming client 106 to the streaming server 111 when the user instructs the video in playback mode to be played back from a position different from the current playback position. At the same time, the time stamp of a new video playback position is also sent together with the jump command. The streaming server 111 immediately sets the timer at the time stamp, specifies data necessary at the received time stamp from metadata, and successively transmits packets including metadata therefrom to the streaming client 106.

(6) Method of How to Schedule Packet Transmission

Next, there will be described how the server device 101 schedules packet transmission including metadata.

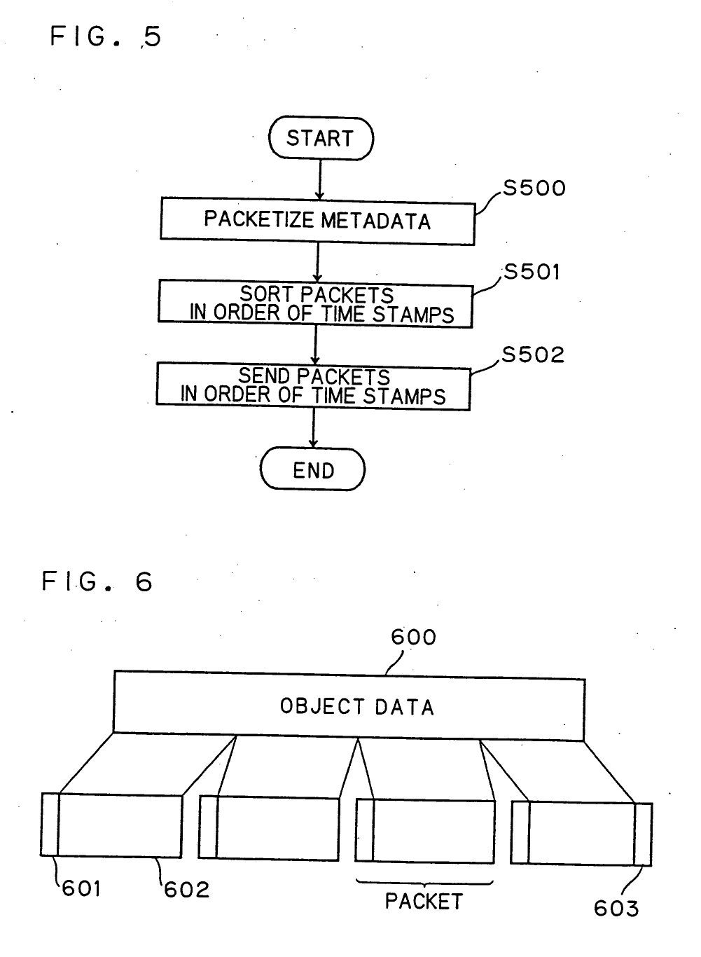

FIG. 5 shows a flowchart of the process of metadata transmission by the streaming server 111.

(6-1) Packetizing Metadata (step S500)

First, in step S500, metadata to be transmitted is divided into packets. Object data included in the metadata is packetized as shown in FIG. 6.

Referring to FIG. 6, reference numeral 600 represents object data for one object.

A header 601 and a payload 602 construct one packet.

The packet always has a fixed length, and the header 601 and the payload 602 also have a fixed length. The object data 600 is divided into parts of the same length as that of the payload 602 and inserted into the payloads 602 of the packets.

Because the length of the object data is not always a multiple of that of the payload 602, the rearmost data of the object data is sometimes shorter than the payload. In such a case, dummy data 603 is inserted to the payload to produce a packet of the same length as other packets. When the object data is shorter than the payload, the object data is inserted in one packet.

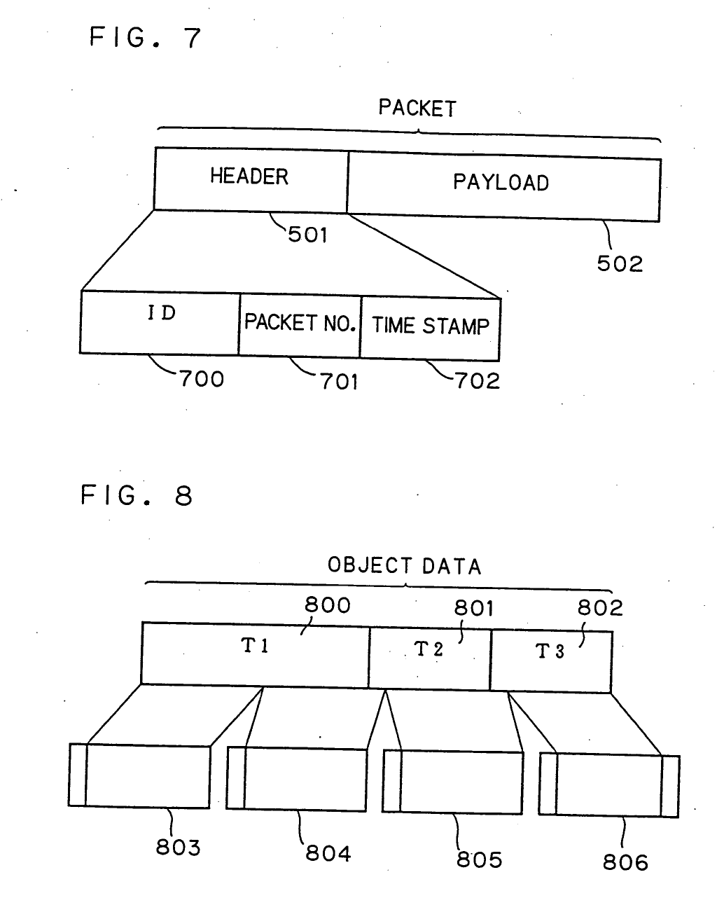

FIG. 7 illustrates the structure of the packet more specifically.

Referring to FIG. 7, reference numeral 700 denotes an ID number. Packets produced from the same object data are assigned the same ID number.

A packet number 701 describes the ordinal number of the packet among the packets produced from the same object data.

A time stamp 702 describes the time at which data stored in the payload 602 becomes necessary. When the packet stores object data, the object-area data 203 includes object-existence time data. Therefore, object-appearance time extracted from the object-existence time data is described in the time stamp 702.

When the object-area data 203 is partial data, even packets produced from the same object data may bear different time stamps. FIG. 8 shows the structure.

Referring to FIG. 8, reference numerals 800 to 802 indicate one object data and reference numerals 803 to 806 denote packets produced from the object data.

The partial data 800 includes the ID number 200, the object display information 201, and the script data 202, and may also include part of the object-area data 203.

The partial data 801 and 802 include only the object-area data 203. Letting T1 be object appearance time, the client device 100 needs the partial data 800 by the time T1. Therefore, the packets 803 and 804 including the partial data 800 are given the time stamp of T1.

On the other hand, among data included in the partial data 801, letting T2 be the time for data that is earliest required by the client device 100, the time stamp of the packet 805 including the partial data 801 is T2.

While the packet 804 includes both the partial data 800 and 801, the earlier time T1 is used. Similarly, among data included in the partial data 802, letting T3 be the time for data that is earliest required by the client device 100, the time stamp for the packet 806 including the partial data 802 is T3.

When the object-area data 203 is described by the MPEG-4 arbitrary shape coding, a different time stamp can be given for each interval between the frames by intra-frame coding (intra-video object plane: I-VOP).

When the object-area data 203 is described by the method of Patent Document 1, different time stamps can be given in units of the interpolating function of the apexes of a figure that indicating an object area.

When the script data 202 included in the object data describes that, when an object is designated by the user, other contents related to the object, such as an HTML file and a still image file are displayed, the related contents can be sent to the client device 100 as metadata. Here it is assumed that the contents data includes both header data describing the file name of the contents and data on the contents in themselves. In such a case, the contents data is packetized as well as the object data. The ID numbers 700 of packets produced from the same contents data are given the same ID number. The time stamp 702 describes the appearance time of a related object.

(6-2) Sorting (Step S501)

After the packetizing process in step S500 has been finished, sorting is performed in step S501.

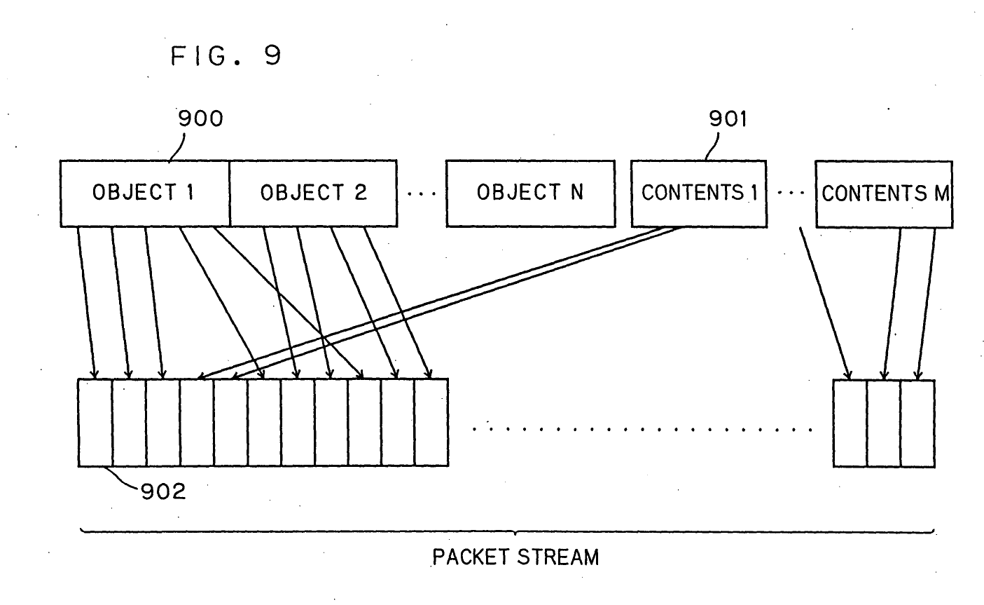

FIG. 9 shows an example of a packet-sorting process in order of time stamps.

Referring to FIG. 9, it is assumed that metadata includes N object data and M contents data.

Reference numeral 900 denotes object data and reference numeral 901 denotes contents data to be transmitted. Packets 902 produced from the data are sorted in order of the time stamp 702 in the packets 902.

Here, the sorted packets that are made into a file are called a packet stream. The packets may be sorted after a metadata transmission command has been received from the client device 100. For decreasing the amount of process, however, it is desired to produce the packet stream in advance.

(6-3) Transmitting (Step S502)

After the sorting process of step S501 has been finished, a transmitting process is performed in step S502.

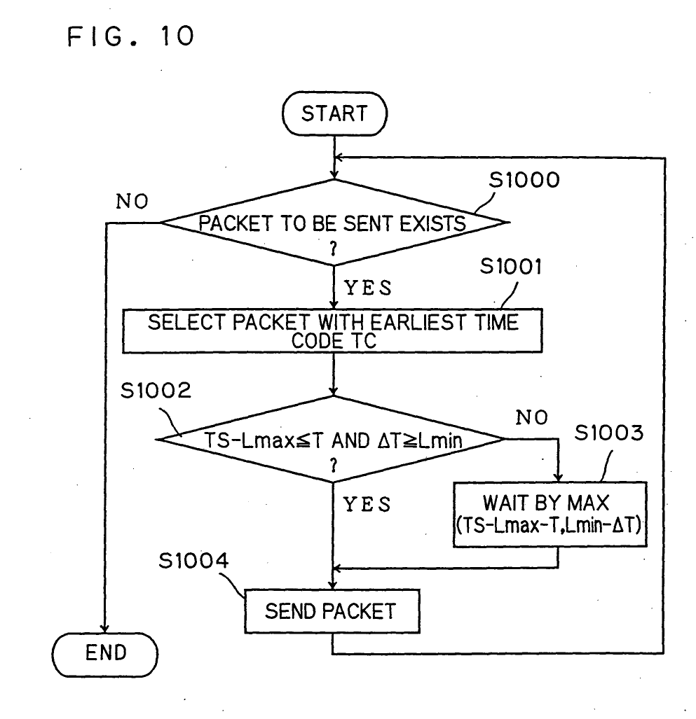

When a packet stream has been produced in advance in steps S500 and S501, processes after the metadata transmission command has been received from the client device 100 may be started from step S503. FIG. 10 shows a flowchart of the detailed process of step S503.

In step S1000, it is determined whether a packet to be transmitted exists. When all the metadata required by the client device 100 has already been transmitted, there is no packet to be transmitted, and thus, the process is finished. On the other hand, when there is a packet to be transmitted, the process proceeds to step S1001.

In step S1001, among packets to be transmitted, a packet having the earliest time stamp is selected. Here, since the packet has already been sorted by the time stamp, it is sufficient to select a packet in sequence.

In step S1002, it is determined whether the selected packet should be immediately transmitted. Here, reference symbol TS denotes the time stamp of the packet; reference symbol T indicates the timer time of the server device 101; and reference symbol Lmax represents a maximum transmission-advance time, which indicates a limit of the transmission advance time when the packet is sent earlier than the time of the time stamp in the packet. The value may be determined in advance, or alternatively, may be calculated from a bit rate and a buffer size described in client specifications which is sent from the streaming client 106. Alternatively, the value may be directly described in the client specifications. Reference symbol ΔT designates time that has passed from the timer time at which the immediately preceding packet is sent to the current timer time. Reference symbol Lmin denotes a minimum packet-transmission interval, which can be calculated from the bit rate and the buffer size described in the client specifications which is sent from the streaming client 106. Only when both of two conditional expressions described in step S1002 are satisfied, the process of S1004 is performed. When one or both of the two conditional expressions are not satisfied, the process in step S1004 must be performed after the process of step S1003.

The process of step S1003 is a process of waiting the transmission of a packet until a packet in selection can be transmitted. Reference symbol MAX(a,b) denotes a larger one of a and b. Therefore, in step S1003, packet transmission is waited by the larger time out of TS-Lmax-T and Lmin-ΔT.

Finally, in step S1004, the packet in selection is transmitted, and the processes from step S1000 are repeated again.

(7) Method for Determining Metadata-transmission Starting position by Streaming Server 111

A method will then be described by which a metadata-transmission starting position by the streaming server 111 is determined when a jump command is sent from the streaming client 106 to the streaming server 111.

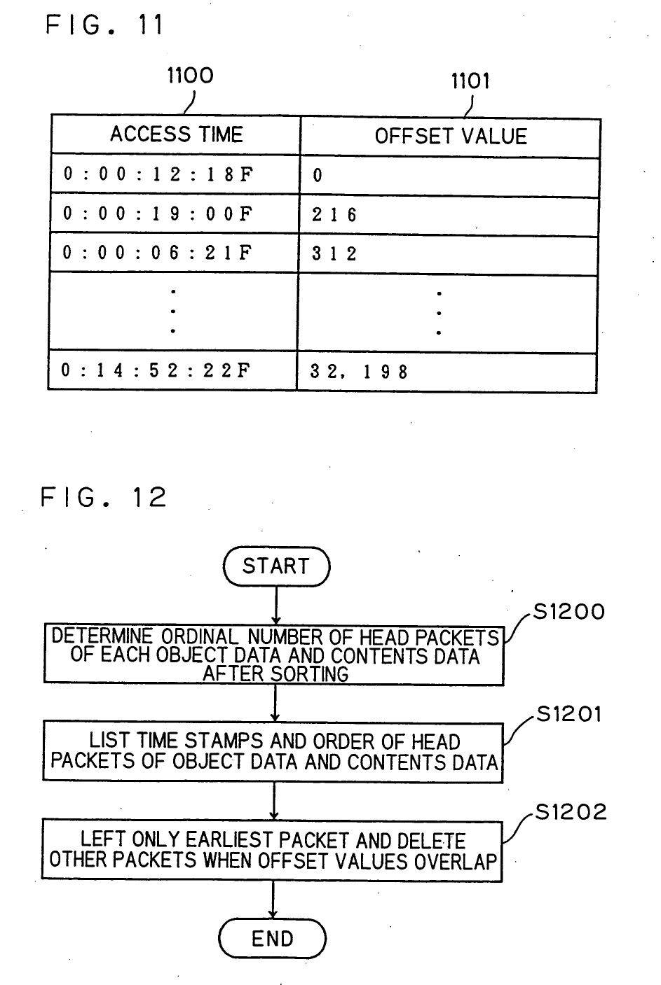

FIG. 11 shows an access-point table for packets used for the streaming server 111 to determine a transmission start packet.

The table is prepared in advance and recorded on the server device 101. A column 1100 indicates access times and a column 1101 shows offset values corresponding to the access times on the left.

For example, when a jump to a time 0:01:05:00F is requested from the streaming client 106, the streaming server 111 searches the access time train for the closest time after the jump destination time. The example in FIG. 11 shows a search result, time 0:01:06:21F. The streaming server 111 then refers to an offset value corresponding to the retrieved time.

In the example of FIG. 11, the offset value is 312. The offset value indicates the ordinal number of a packet to be transmitted. Therefore, when a packet stream has been produced in advance, it is preferable to start to transmit the 312th packet in the packet stream.

The access point table for the packets is produced as in the flowchart of FIG. 12.

In step S1200, it is first determined on the ordinal number of the head packet of each object data and contents data in order of the time stamp after sorting. This can be performed in synchronization with the step S501 in FIG. 5.

In step S1201, the orders of packets including the head packet in each object data and contents data are set to offset values, and are listed with the time stamps of the packets, thereby the table is produced. The table sometimes has different offset values corresponding to the same time stamp. Therefore, in step S1202, only a minimum offset value is left and other overlapping time stamps are deleted.

By the above processes, the access point table for the packets is produced. In the access point table, the packet in the table of offset values always corresponds to the head of the object data or the contents data. Therefore, starting the transmission by the streaming server 111 from the packet allows the client device 100 to obtain object data or contents data which is necessary at the video playback position.

(8) Another Method for Determining Metadata-transmission Starting Position by Streaming Server 111

Another method will be described by which a metadata-transmission starting position by the streaming server 111 is determined when a jump command is sent from the streaming client 106 to the streaming server 111.

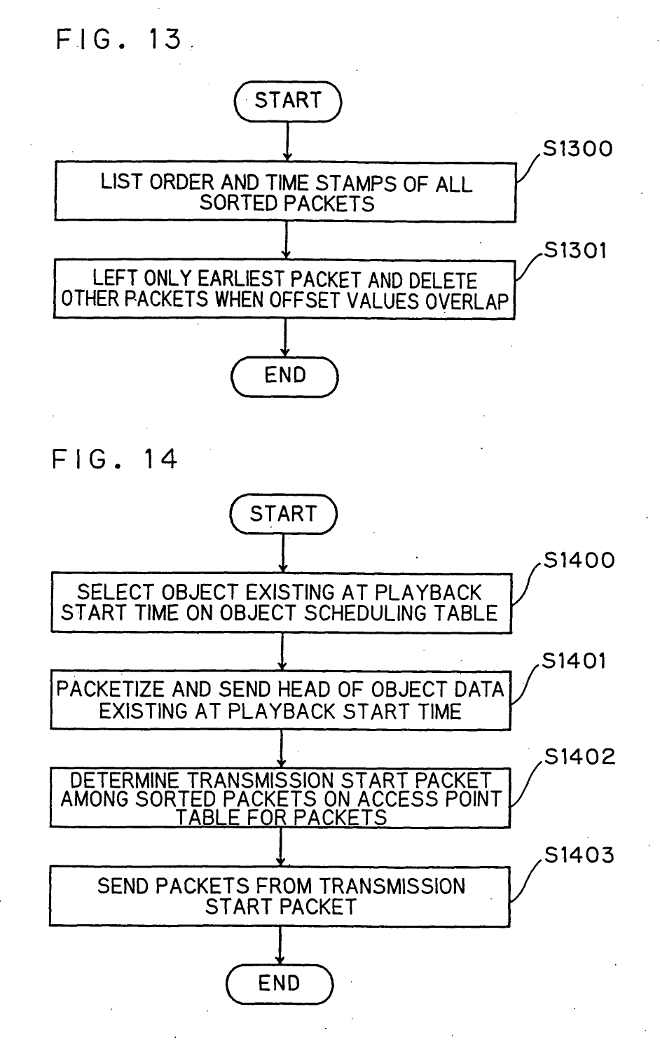

A packet access point table is first prepared by a method different from that in FIG. 12. FIG. 13 shows a flowchart of the procedure.

In step S1300, the orders (offset values) of all the packets that have been sorted in order of the time stamps and the time stamps of the packets are first listed to produce the table.

In step S1301, overlapping time stamps are deleted. More specifically, when the produced table includes an overlapping offset value at the same time stamp, only a minimum offset value is left and other overlapping time stamps and offset values are deleted.

In order to start metadata transmission using the access point table for packets thus produced, a method different from that of FIG. 12 must be used. The method will be described hereinafter.

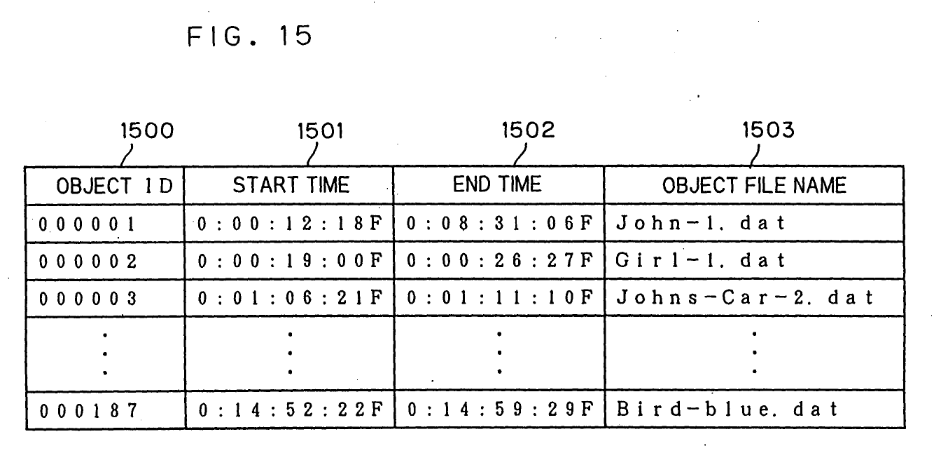

FIG. 14 shows a flowchart for starting metadata transmission using the access-point table for packets produced by the method of FIG. 13.

In step S1400, among the object data, an object existing in the video at a playback start time required by the client device 100 is specified. For this purpose, an object scheduling table is referred. The table is prepared in advance and recorded in the client device 100.

FIG. 15 shows an example of the object scheduling table.

Object ID numbers 1500 correspond to the object-data ID numbers 200.

Start time 1501 describes the time when the object area in the object-area data 203 starts.

End time 1502 describes the time when the object area in the object-area data 203 ends.

An object file name 1503 specifies the file name of the object data.

The example of FIG. 15 shows that, for example, an object having an object ID number 000002 appears on the screen at time 0:00:19:00F and disappears at time 0:00:26:27F, and the data about the object is described in a file Girl-1.dat.

In step S1400, an object is selected which includes a playback start time required by the client device 100 between the start time and the end time on the object scheduling table.

In step S1401, the file name of the selected object is taken from the object scheduling table, from which object data other than the object-area data 203 is packetized and transmitted.

In step S1402, a transmission start packet is determined. In the process, among the sorted packets, a transmission start packet is determined with reference to the access point table for packets produced by the process of FIG. 13.

Finally, in step S1403, packets are transmitted from the transmission start packet in sequence.

On the packet access point table produced by the procedure of FIG. 13, the packet indicated by the offset value does not always correspond to the head of the object data. Accordingly, when the transmission is started from a packet designated by the offset value, important information such as the ID number 200 and the script data 202 in the object data is omitted. In order to prevent the omission, only the important information in the object data is first transmitted, and other packets are then transmitted in order of designation by the offset values on the packet access point table.

[Modification]

Although object data and contents data are used as metadata in the above description, other metadata can be processed such that the metadata is sent from the server device 101 to the client device 100 and it is processed in synchronization with the playback of video or audio contents held in the client device 100.

For example, the invention can be applied to all metadata in which different contents are described for each time, such as video contents or audio contents.

What is claimed is:

1. A client device capable of accessing a hypermedia-data server device through a network, comprising:
a playback unit to play back a moving image;
a time-stamp transmission unit to transmit the time stamp of the image in playback mode to the server device;
a metadata receiving unit to receive metadata having information related to the contents of the image at each time stamp from the server device by streaming distribution in synchronization with the playback of the moving image; and
a controller to display the received metadata or performing control on the basis of the metadata in synchronization with the playback of the image.

2. A client device according to claim 1, wherein the metadata includes:
object-area data specifying the area of an object appearing in the image corresponding to each time stamp; and
data specifying contents to be displayed when the area specified by the object-area data is designated or an action to be performed when the area specified by the object-area data is designated.

3. A client device according to claim 1, wherein, when the metadata is received by streaming distribution, the time-stamp transmitting unit adjusts timer time at which the time stamp to be transmitted to the server device is produced in accordance with the time stamp of the image.

4. A server device capable of accessing a hypermedia-data client device through a network, comprising:
a metadata storage unit to store metadata having information related to the contents of an image corresponding to each time stamp of a moving image to be played back by the client device;
a time-stamp receiving unit to receive the time stamp of the image to be played back, the time stamp being transmitted from the client device; and
a metadata transmission unit to transmit the stored metadata to the client device by streaming distribution in synchronization with the playback of the image in accordance with the received time stamp.

5. A server device according to claim 4, wherein the metadata includes:
object-area data specifying the area of an object appearing in the image corresponding to each time stamp; and
data specifying contents to be displayed when the area specified by the object-area data is designated or an action to be performed when the area specified by the object-area data is designated.

6. A server device according to claim 4, wherein the metadata transmission unit adjusts a timer time to be used when the metadata to be distributed and the distribution timing are determined in accordance with the received time stamp.

7. A server device according to claim 4, wherein, when the metadata to be distributed and the distribution timing are determined, the metadata transmission unit determines the transmission timing of partial data in the metadata by using data-transmission interval calculated from the timer time and the data transfer speed of the streaming distribution and an allowed time difference between the time stamp and the partial data of the metadata to be transmitted next.

8. A server device according to claim 4, further comprising:
a position-correspondence-table storage unit to store position-correspondence table in which a time stamp and a storage position of metadata related to the time stamp are in correspondence with each other;
wherein, upon receiving playback start time for the moving image, the metadata transmission unit sequentially sends the metadata by streaming distribution from a metadata storage position specified with reference to the position-correspondence table.

9. A server device according to claim 4, further comprising:
a first-table storage unit to store a first table that brings the sections of the time stamps related to a plurality of pieces of the metadata into correspondence with information for specifying the metadata; and
a second-table storage unit to store a second table that brings the time stamps into correspondence with storage positions of metadata related to the time stamps;
wherein, upon receiving playback start time for the moving image, the metadata transmission unit sends partial data of the metadata specified with reference to the first table by streaming distribution, and then sequentially sends the metadata from the storage position specified with reference to the second table by streaming distribution.

10. A method for playing back a moving image in a client device capable of accessing a hypermedia-data server device through a network, comprising:
playback step of playing back the moving image;
time-stamp transmission step of transmitting the time stamp of the image in playback mode to the server device;
metadata receiving step of receiving metadata having information related to the contents of the image at each time stamp from the server device by streaming distribution in synchronization with the playback of the moving image; and
control step of displaying the received metadata or performing control on the basis of the metadata in synchronization with the playback of the image.

11. A method for transmitting data in a server device capable of accessing a hypermedia-data client device through a network, comprising:
time-stamp receiving step of receiving the time stamp of an image to be played back, the time stamp being transmitted from the client device; and
metadata transmission step of transmitting metadata having information related to the contents of an image corresponding to each time stamp of a moving image to be played back by the client device to the client device by streaming distribution in synchronization with the playback of the image on the basis of the received time stamp.
